(19) United States
(12) Patent Application Publication
(10) Pub. No.: US 2016/0062373 A1
(43) Pub. Date: Mar. 3, 2016

(54) ADAPTIVE LOADING AND COOLING

(71) Applicant: Intel Corporation, Santa Clara, CA (US)

(72) Inventor: Jeffrey Howard King, Portland, OR (US)

(21) Appl. No.: 14/473,883

(22) Filed: Aug. 29, 2014

(51) Int. Cl. G05D 23/19; G05B 15/02

(52) U.S. Cl. CPC G05D 23/19; G05B 15/02

(57) ABSTRACT

Apparatuses, methods and storage media associated with preferential loading of nodes of an electronic device are disclosed herein. In embodiments, a controller may identify a first node that is upstream of a second node. The controller may preferentially assign workload to the first node before assigning workload to the second node. Finally, the controller may alter a cooling rate of the cooling device based on the assignment of workload. Other embodiments may be described and/or claimed.

### TECHNICAL FIELD

The present disclosure relates to the field of thermal cooling for electronic devices, and specifically to adaptive loading and cooling of nodes in electronic devices.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

The demand for server infrastructure tailored to dedicated hosting, content delivery, and web front end continues to grow as the web and mobile market segments expand exponentially. Traditional server infrastructure may not be well suited to these workloads. Instead, solution providers may group large numbers of lightweight system on a chip (SoC) parts together to target these workloads, which may lead to the increasing prevalence of so-called microservers. While a traditional system may have the power budget and/or physical volume to accommodate two to four traditional servers, perhaps ten times as many SoC-based nodes may fit within the same power and size envelopes. As such, SoC-based microserver nodes may be arranged in large physical arrays or matrices within systems.

Unfortunately, all locations within a matrix of microserver nodes may not be thermally equivalent to one another. Specifically, if nodes are arranged in series with respect to server airflow, the nodes located farthest downstream may be preheated by upstream nodes and therefore experience higher local ambient air temperatures.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example electronic device that includes a matrix of nodes, in accordance with various embodiments.

FIG. 2 illustrates as an example process for adaptively loading and cooling nodes in an electronic device, in accordance with various embodiments.

FIG. 3 illustrates an example computer system suitable for use to practice various aspects of the present disclosure, in accordance with various embodiments.

FIG. 4 illustrates a storage medium having instructions for practicing processes described with reference to FIG. 2, in accordance with various embodiments.

### DETAILED DESCRIPTION

Disclosed embodiments include apparatuses, methods and storage media associated with preferential loading and cooling of nodes in an electronic device. In embodiments, workload may be preferentially assigned to upstream nodes of the electronic device prior to assigning workload to nodes of the electronic device that are downstream nodes. As used herein, if the cooling devices cool the nodes by blowing air over the nodes, then the upstream nodes may be nodes that are closer to the cooling devices than the downstream nodes. By contrast, if the cooling devices cool the nodes by drawing air over the nodes, then the upstream nodes may be nodes that are farther from the cooling devices than the downstream nodes. Based on this assignment of workload, the cooling rate of the cooling devices may be further altered to reduce or otherwise minimize the power consumption of the cooling devices. As used herein, “cooling rate” may refer to the speed at which the cooling devices cool one or more nodes. For example, “cooling rate” may refer to fan speed if the cooling devices are cooling fans.

As discussed herein, nodes may include electrical and/or optical components such as processors, central processing units (CPUs), memory such as dynamic random access memory (DRAM), flash memory, dual inline memory modules (DIMMs), logic, a peripheral component interconnect express (PCIe) card, an audio chip, a graphics chip, read-only memory (ROM), a wired or wireless communication chipset, a hard disk drive (HDD), SoCs, microservers, or other components. It will be understood that the above description of electrical and/or optical components is intended as a non-exhaustive list of descriptive examples, and additional or alternative components to those listed above may be used in other embodiments. In some embodiments, the nodes may be referred to as “server nodes.”

In the following detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

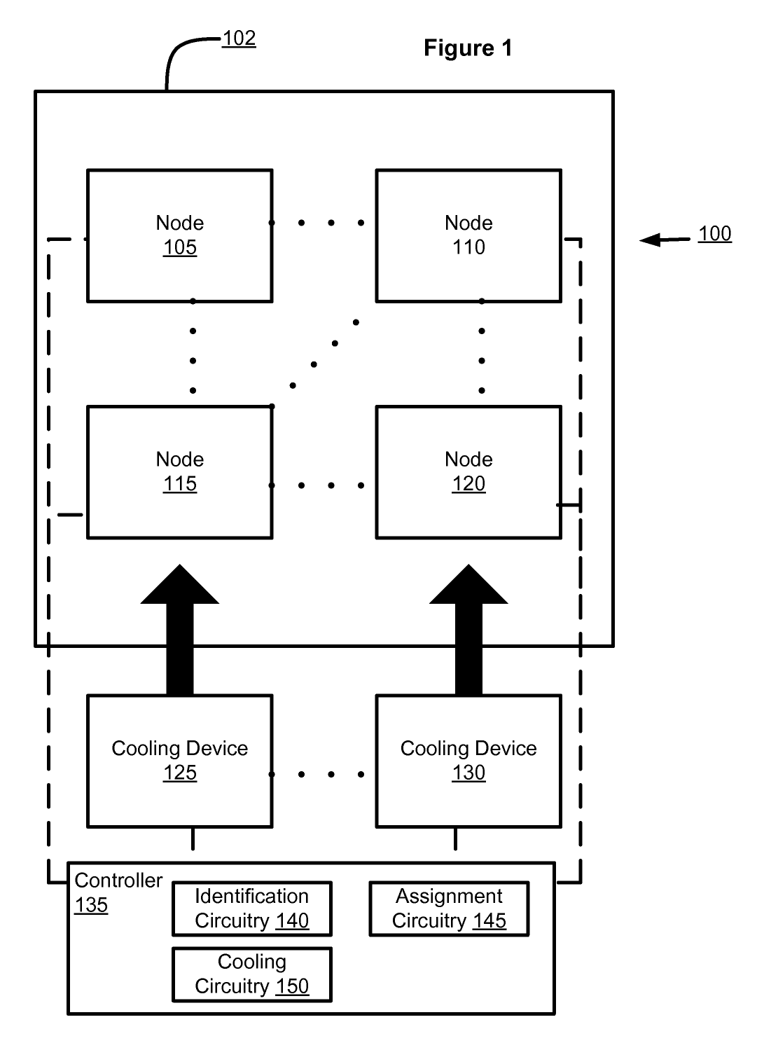

FIG. 1 illustrates an example electronic device 100. The electronic device 100 may be, for example, a server or a server blade in a rack server. In some embodiments, the electronic device 100 may be a smartphone, a tablet computer, an ultrabook, an e-reader, a laptop computer, a desktop computer, a set top box, a digital video recorder, an audio amplifier, and/or a game console. The electronic device 100 may include a circuit board 102. In some embodiments, the circuit board 102 may have one or more nodes 105, 110, 115, and 120 coupled with the circuit board 102. For example, in the embodiment depicted in FIG. 1, the circuit board 102 may include one or more nodes such as a peripheral component interconnect express (PCIe) card, a DIMM, a CPU, an SoC, or one or more of the other types of nodes described elsewhere in this specification.

In some embodiments, the nodes of the circuit board 102 may be arranged as a matrix. For example, as shown in FIG. 1, the nodes 105, 110, 115, and 120 may be arranged in a 2×2 matrix. Nodes 115 and 120 may form a first row of nodes in the matrix. Nodes 105 and 110 may form a second row of nodes in the matrix. Similarly, nodes 115 and 105 may form a first column of nodes in the matrix. Nodes 110 and 120 may form a second column of nodes in the matrix. In embodiments, the circuit board 102 may include more or fewer rows or columns of nodes. For example, as indicated by the dotted lines in FIG. 1, a column of nodes in the matrix may include more nodes than are depicted in FIG. 1. Additionally, as indicated by the dotted lines in FIG. 1, a row of nodes in the matrix may include more nodes than are depicted in FIG. 1. In some embodiments, the matrix may include four nodes arranged in a 2×2 matrix (as shown). In other embodiments, the matrix may include 60 nodes arranged in a 6×10 matrix. In other embodiments, the matrix may include more or less nodes arranged in a different number of rows and/or columns. In some embodiments, the matrix may include only a single column or single row of nodes. In other embodiments, each row or column of nodes may include as many as twelve nodes. Although the matrix is depicted as a two-dimensional matrix, in some embodiments the matrix may be a three-dimensional matrix of nodes.

The electronic device 100 may further include one or more cooling devices 125 and 130. For the sake of clarity, the cooling devices 125 and 130 may generally be referred to as fans or cooling fans in the discussion below; however, in other embodiments the cooling device may be a heatsink or some other type of active or passive cooling device. In some embodiments, each of cooling devices 125 and 130 may be a single fan or heatsink, while in other embodiments each of cooling devices 125 and 130 may include a plurality of fans, heatsinks, other active or passive cooling components, or combinations thereof. As shown in FIG. 1, the cooling devices 125 and 130 may be separate from the circuit board 102, and in other embodiments the cooling devices 125 and 130 may be coupled with the circuit board 102. Generally, the cooling devices 125 and 130 may be configured to cool one or more of nodes 105, 110, 115, and 120, either by blowing air over the nodes, drawing air over the nodes, or otherwise removing heat from the nodes.

As depicted by the arrows in FIG. 1, cooling devices 125 and 130 may be configured to blow air over nodes 105, 110, 115, and 120. Therefore, nodes 115 and 120 may be considered to be upstream of nodes 105 and 110. Similarly, nodes 105 and 110 may be configured to be downstream of nodes 115 and 120.

In other embodiments (not shown) where cooling devices 125 and 130 cool nodes by drawing air over the nodes, nodes 105 and 110 may be considered to be upstream of nodes 115 and 120. Nodes 115 and 120 may be considered to be downstream of nodes 105 and 110.

In other embodiments (not shown) where cooling devices 125 and 130 are located generally between the row of nodes including nodes 105 and 110 and the row of nodes including nodes 115 and 120, the cooling devices 125 and 130 may cool nodes 105, 110, 115, and 120 by drawing air over nodes 105 and 110 and then pushing air over nodes 115 and 120 (or vice versa). In those embodiments, nodes 105 and 110 may be considered to be upstream of nodes 115 and 120 (or vice versa). Nodes 115 and 120 may be considered to be downstream of nodes 105 and 110 (or vice versa).

In other embodiments, the cooling devices 125 and 130 may be coupled with the circuit board 102. In some embodiments, each cooling device may be individually configured to cool a column of nodes. For example, cooling device 125 may be configured to cool the column of nodes that includes nodes 105 and 115. Similarly, cooling device 130 may be configured to cool the column of nodes that includes nodes 110 and 120. In other embodiments, a cooling device may be configured to cool multiple columns of nodes.

As shown in FIG. 1, electronic device 100 may further include a controller 135 that may be coupled with one or more of nodes 105, 110, 115, and 120; and cooling devices 125 and 130. In some embodiments, the controller 135 may include or be coupled with identification circuitry 140, assignment circuitry 145, and cooling circuitry 150, as will be discussed in greater detail below. In some embodiments, one or more of the identification circuitry 140, assignment circuitry 145, and cooling circuitry 150 may be combined with one another. In some embodiments, one or more of the identification circuitry 140, assignment circuitry 145, and cooling circuitry 150 may be separate from, but communicatively coupled with, the controller 135.

In embodiments, the controller 135, and particularly the assignment circuitry 145, may be configured to preferentially assign workload to one or more of nodes 105, 110, 115, and 120, as will be described in further detail below. The controller 135, and particularly the cooling circuitry 150, may further be configured to control the cooling rate of cooling devices 125 or 130 based on that workload assignment, as will be described in further detail below. As used herein, “workload” may refer to one or more operations, processing, memory access, or other actions where a node may perform one or more actions and/or generate heat.

As described above, when nodes are arranged in series, downstream nodes may experience increased local temperatures compared to upstream nodes due to the cooling devices blowing preheated air from upstream nodes onto the downstream nodes. In the embodiment shown in FIG. 1, nodes 105 and 110 may be considered to be downstream of nodes 115 and 120, as described above. In this embodiment, if the cooling device 125 is blowing air on nodes 115 and 105 to cool nodes 115 and 105, the cooling device may actually blow air that was warmed by node 115 onto node 105, thus increasing the local ambient temperature at or near node 105. In embodiments, the arrangement of nodes 105 and 115 and cooling device 125 may be referred to as a “shadowed” arrangement.

One way to resolve the increased local temperature of downstream nodes may be to preferentially distribute workloads to nodes based upon their position within the airstream, with the nodes farther upstream being loaded (or assigned workload) first. For example, for the embodiment shown in FIG. 1, it may be desirable for controller 135, and particularly assignment circuitry 145, to distribute workload to nodes 115 and 120 before distributing workload to nodes 105 and 110 because nodes 115 and 120 are upstream of nodes 105 and 110.

This approach may be useful because in some embodiments there may be as many as twelve nodes arranged in series with a given airstream, as noted above. Loading based upon position in the airstream may allow the controller 135 to use a corresponding cooling rate control policy that may minimize or reduce cooling rate, thereby optimizing power consumption of the electronic device 100. This optimization of the power consumption of electronic device 100 may be particularly effective for electronic devices or systems that are only partially loaded, that is electronic devices or systems that do not include the maximum number of nodes on a circuit board such as circuit board 102.

In some embodiments, the circuit board 102 may include one or more sensors (not shown) that may be near one or more of nodes 105, 110, 115, and 120. The sensor(s) may be coupled with the controller 135 and configured to detect the temperature at or near each of the nodes 105, 110, 115, and 120. Based on the temperature(s) reported by the sensor(s), the controller 135, and particularly cooling circuitry 150, may alter the cooling rate of one or more of cooling devices 125 and 130 to cool the nodes 105, 110, 115, and 120. For example, if only a few of the nodes 105, 110, 115, and 120 are operating, or only the nodes that are farthest upstream such as upstream nodes 115 and 120 are operating, then the controller 135, and particularly the cooling circuitry 150, may reduce the cooling rate of cooling devices 125 and 130 because the electronic device 100 may not be experiencing a high-temperature scenario. However, if all of the nodes 105, 110, 115, and 120 are operating, the temperature at or near downstream nodes 105 and 110 may be relatively high and a significant amount of cooling of the electronic device 100 may be required. Therefore, the controller 135, and particularly the cooling circuitry 150, may increase the cooling rate of cooling devices 125 and 130.

In some embodiments electronic device 100 may use aggregated cooling architectures. That is, a plurality of nodes may share common cooling devices as shown in FIG. 1 where nodes 105 and 115 are both cooled by cooling device 125. In these embodiments, the hottest node among the plurality of nodes may drive the cooling rate of the cooling devices. Therefore, if several downstream nodes are used (which may be hotter than upstream nodes as described above), then the downstream nodes may drive the cooling rate of the cooling devices by having a higher temperature that is identified by the sensor(s) and reported to controller 135. Therefore, it may be useful to preferentially assign workload to the upstream nodes to avoid the situation of having un-necessarily hot downstream nodes.

As an example of how the heat may fluctuate between upstream and downstream nodes, assume (for the purposes of this descriptive example only) that each of nodes 105, 110, 115, and 120 dissipates 20W of power under a thermal design power workload (which may be 80% of the maximum workload of each of the nodes). Also, assume (for the purposes of this descriptive example only) that the matrix of FIG. 1 contains 25 nodes arranged in a 5×5 matrix. In this example, all 25 nodes may share common cooling devices, so the hottest node or nodes may establish the cooling rate of the cooling devices that may result in 50 cubic feet of air per minute to properly cool all of the nodes in the system. Finally, assume (for the purposes of this descriptive example only) that the external ambient temperature may be 35° C.

In this example, the local ambient temperature at or near a farthest upstream node such as node 115 may be approximately 35° C. However, the next node that is downstream of the farthest upstream node 115 may have air that is heated by upstream node 115 blown on it. Therefore, the local ambient temperature of that next node may be approximately 38.9° C. This shadowing effect may compound until the farthest downstream node, for example, node 105, may have a local ambient temperature of approximately 50.6° C. at or near node 105. The temperature at or near the farthest downstream node 105 may be the temperature that drives the cooling rate of cooling device 125, which may result in significant power being spent on cooling each of the nodes of the electronic device 100.

However, if all of the nodes of an electronic device such as electronic device 100 are not being used, then the controller 135, and specifically the assignment circuitry 145, may be configured to preferentially assign workload to upstream nodes prior to assigning workload to downstream nodes. Specifically, with reference to FIG. 1, if only two of nodes 105, 110, 115, and 120 are required to fully process the amount of workload currently required by electronic device 100, then the workload may be preferentially assigned to upstream nodes 115 and 120 by controller 135, and specifically the assignment circuitry 145.

If the matrix of nodes included, for example, five rows of nodes, then the controller 135, and specifically the assignment circuitry 145, may preferentially assign workload to the row of nodes that is farthest upstream before assigning workload to downstream nodes. If the amount of workload cannot be handled by the row of nodes that is farthest upstream, then the controller 135, and specifically the assignment circuitry 145, may further assign workload to the row of nodes that is next farthest upstream, and so on.

After assigning workload to the nodes, then the controller 135 may further monitor the temperature of each of the nodes 105, 110, 115, and 120, for example, via the sensor(s) as described above. Based on the temperature(s) at one or more of the nodes reported by the sensor(s) described above, the controller 135, and specifically the cooling circuitry 150, may alter the cooling rate of one or more of cooling devices 125 or 130. In some embodiments, the controller 135, and specifically the cooling circuitry 150, may alter the cooling rate of the cooling device(s) 125 and/or 130 based on a calculation of necessary cooling such that the power consumption of the cooling device(s) 125 and 130 is optimized. In other embodiments, the controller 135, and specifically the cooling circuitry 150, may choose between one or more different pre-loaded or pre-identified configurations of cooling rate. For example, a first pre-loaded or pre-identified configuration may be used for a first temperature range, a second pre-loaded or pre-identified configuration may be used for a second temperature range, etc.

Although embodiments and examples above are described with reference to the use of one or more sensor(s) to identify temperature near one or more of the nodes 105, 110, 115, and 120, in other embodiments the controller 135 may identify the necessary cooling rate or cooling configurations of cooling devices 125 and 130 based on one or more other criteria. For example, in some embodiments the controller 135 may be able to identify the workload assigned to each of nodes 105, 110, 115, and 120. For example, the controller 135 may be able to identify the amount of information being fed into one or more of nodes 105, 110, 115, and 120, the amount of information exiting one or more of the nodes, the number of processes that may be requested of the nodes in a given time period, the relatively complexity of a process assigned to one or more of the nodes, or one or more other factors. The controller 135 may then be able to calculate or otherwise identify a necessary cooling rate of cooling devices 125 and 130 based on the assigned workload. As a specific example, in some embodiments the controller 135 may identify that workload is only being performed by nodes 115 and 120, and so the controller 135 may identify a first cooling rate configuration with a reduced power consumption and reduced cooling rate related to that assignment than if the workload were assigned to a node downstream from nodes 115 and/or 120. If the controller 135 then assigns workload to nodes 105 and/or 110, then the controller may be able to identify a second cooling rate configuration with an increased power consumption and increased cooling rate than if the workload were assigned to a node upstream from nodes 105 and/or 110.

In embodiments above, nodes 115 and 120 are described as being upstream of nodes 105 and 110; that is, cooling devices 125 and 130 may blow hot air from nodes 115 and 120 onto nodes 105 and 110. However, in other embodiments (not shown), the cooling devices 125 and 130 may draw air from the various nodes to cool the nodes. In these embodiments, nodes 105 and 110 may be considered to be upstream of nodes 115 and 120. That is, if cooling devices 125 and 130 are drawing air over nodes 105, 110, 115, and 120 (i.e., opposite of the direction air is shown blowing in FIG. 1), then the cooling devices 125 and 130 may draw air from nodes 105 and 110 over nodes 115 and 120. In these embodiments, the controller 135, and specifically the assignment circuitry 145, may preferentially assign workload to nodes 105 and 110 prior to assigning workload to nodes 115 and 120.

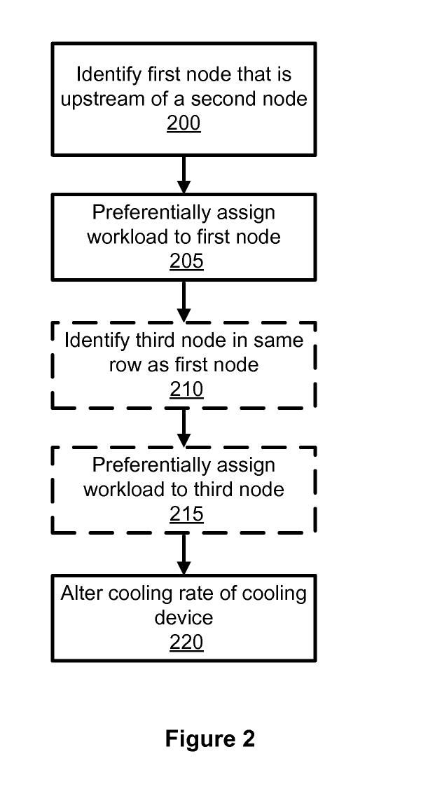

FIG. 2 depicts a high-level example process that may be performed by a component of the electronic device 100 such as controller 135. Initially, the controller, and specifically the identification circuitry 140, may identify a first node that is upstream of a second node at 200. For example, the controller 135, and specifically the identification circuitry 140, may identify a first node that is closer to a cooling device if the cooling device is configured to blow air over the nodes. For example, if the controller 135 needs to assign a workload, then the controller 135, and specifically the identification circuitry 140, may identify that node(s) 115 and/or 120 are upstream of node(s) 105 and/or 110. In other embodiments where the cooling device is configured to draw air over the nodes, the controller 135, and specifically the identification circuitry 140, may identify that node(s) 105 and/or 110 are upstream of node(s) 115 and/or 120.

Based on that identification, the controller 135, and specifically the assignment circuitry 145, may preferentially assign workload to the identified first node at 205. Specifically, the controller 135, and specifically the assignment circuitry 145, may assign the workload to node(s) 115 and/or 120 prior to assigning workload to node(s) 105 and/or 110.

Next, if the controller 135 needs to further assign a workload, in some embodiments the controller 135, and specifically the identification circuitry 140, may optionally further identify a third node that is in the same row as the first node at 210. For example, if the controller 135 and/or assignment circuitry 145 preferentially assigned workload to node 115 at 205, then the controller 135 and specifically the identification circuitry 140 may identify node 120 at 210. In embodiments, the electronic device 100 may only have a single column of nodes such as nodes 105 and 110, and therefore the third node may not be identified at 210 because it may not exist. However, if the electronic device 100 includes a row of nodes such as row 115 and 120 that are upstream of nodes such as nodes 105 and 110 (as described above), then node 120 may be identified at 210 as described above.

Based on the identification at 210, the controller 135, and specifically the assignment circuitry 145, may optionally preferentially assign workload to the third identified node at 210. Specifically, if the controller 135 and/or assignment circuitry 145 assigned workload to node 115 at 205, then the controller 135 and/or assignment circuitry 145 may preferentially assign workload to node 120 at 215. In summary, if a first row of nodes is upstream of a second row of nodes, the controller 135 and/or assignment circuitry 145 may preferentially assign workload to nodes in the first row of nodes prior to assigning any workload to nodes in the second row of nodes.

Finally, the controller 135, and specifically the cooling circuitry 150, may alter at 220 the cooling rate of one or more of the cooling device(s) 125 and/or 130 based on that assignment at 205 and/or 215. For example, if the controller 135 only assigns workload to node 115 (and/or 120), then the controller 135, and specifically the cooling circuitry 150, may reduce or minimize the cooling rate of cooling device 125. In general, the cooling rate of one or more of the cooling devices may be based on the hottest nodes or nodes that the cooling device is attempting to cool, as described above.

In some embodiments, the third node may be identified at 210 based on one or more other criteria. For example, in some embodiments the third node may be identified at 210 based on the workload status of certain other of the nodes, the configuration of the cooling device(s) 125 and/or 130, or some other factor. As a specific example, cooling device 125 may be configured to cool two columns of nodes, and cooling device 130 may be configured to cool two other columns of nodes. In embodiments, a farthest upstream node in a column cooled by cooling device 130 may already have workload assigned to it, and the controller 135 may identify that there is additional required workload. In embodiments, the controller 135 and/or assignment circuitry 145 may preferentially assign the additional workload to the node that is farthest upstream in the column that is also cooled by cooling device 130, rather than assigning the workload to a node that is cooled by cooling device 125. That way, only cooling device 130 may be required to operate to cool the two operating nodes, rather than requiring both cooling device 130 and 125 to operate.

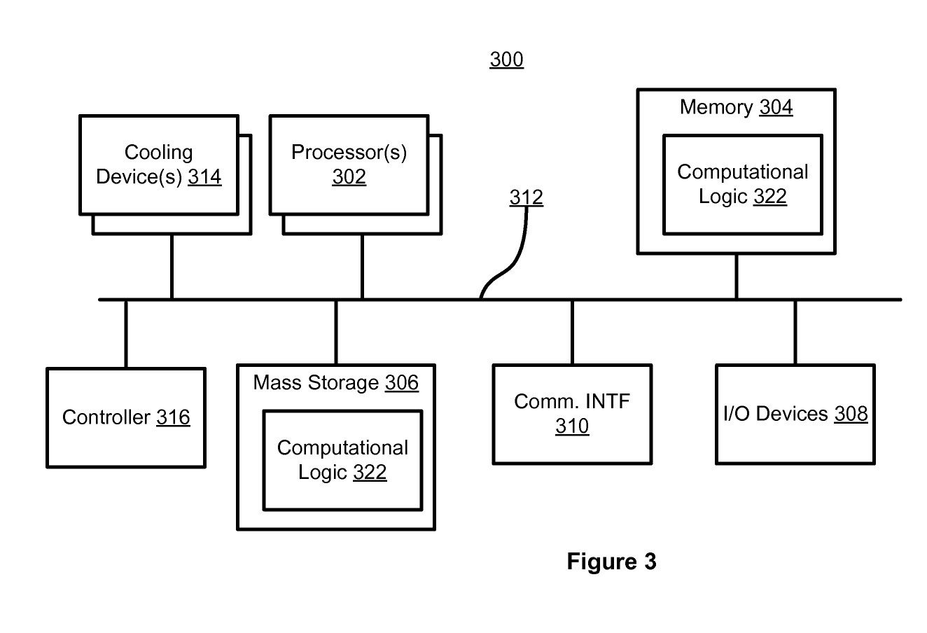

FIG. 3 illustrates an example electronic device (e.g., computer 300) that may be suitable for use as a client device or a server to practice selected aspects of the present disclosure. As shown, computer 300 may include one or more processors or processor cores 302, and system memory 304. For the purpose of this application, including the claims, the terms “processor” and “processor cores” may be considered synonymous, unless the context clearly requires otherwise. Additionally, computer 300 may include mass storage devices 306 (such as diskette, hard drive, compact disc read-only memory (CD-ROM) and so forth), input/output (I/O) devices 308 (such as display, keyboard, cursor control and so forth) and communication interfaces 310 (such as network interface cards, modems and so forth). The elements may be coupled to each other via system bus 312, which may represent one or more buses. In the case of multiple buses, they may be bridged by one or more bus bridges (not shown). Further, computer 300 may include one or more cooling devices 314 (such as cooling devices 125 or 130 of FIG. 1), and controller 316 (such as controller 135 of FIG. 1).

As described earlier, processors 302, memory 304, mass storage 306, components of communications interface 310, I/O devices 308, or selected ones of like elements that discharge heat may be arranged in a configuration with some like elements being closer to cooling devices 314 while other like elements are further from cooling devices 314, such as controller 316 may preferentially assign workload and/or adapt the cooling rate of cooling devices 314.

Each of these elements may perform its conventional functions known in the art. In particular, system memory 304 and mass storage devices 306 may be employed to store a working copy and a permanent copy of the programming instructions implementing the operations associated with the process of FIG. 2, earlier described, collectively referred to as computational logic 322. The various elements may be implemented by assembler instructions supported by processor(s) 302 or high-level languages, such as, for example, C, that can be compiled into such instructions.

The number, capability and/or capacity of these elements 310-316 may vary, depending on whether computer 300 is used as a client device or a server. When used as a client device, the capability and/or capacity of these elements 310-316 may vary, depending on whether the client device is a stationary or mobile device, like a smartphone, computing tablet, ultrabook or laptop. Otherwise, the constitutions of elements 310-316 may be known, and accordingly will not be further described. When used as a server device, the capability and/or capacity of these elements 310-312 may also vary, depending on whether the server is a single stand-alone server or a configured rack of servers or a configured rack of server elements.

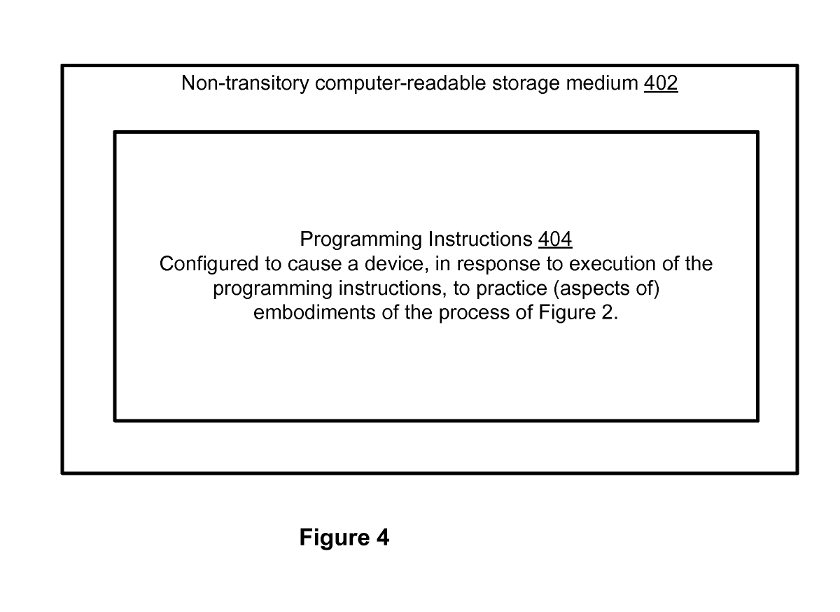

As will be appreciated by one skilled in the art, aspects of the present disclosure may be embodied as methods or computer program products. Accordingly, the present disclosure, in addition to being embodied in hardware as earlier described, may take the form of an entire software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium. FIG. 4 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 402 may include a number of programming instructions 404. Programming instructions 404 may be configured to enable a device, e.g., controller 316 of computer 300, in response to execution of the programming instructions, to perform, e.g., various operations associated with the process of FIG. 2. In alternate embodiments, programming instructions 404 may be disposed on multiple computer-readable non-transitory storage media 402 instead. In alternate embodiments, programming instructions 404 may be disposed on computer-readable transitory storage media 402, such as signals.

Any combination of one or more computer-usable or computer-readable medium(s) may be utilized. The computer-usable or computer-readable medium may be, for example, but is not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, radio frequency (RF), etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means that implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments may be implemented as a computer process, a computing system or an article of manufacture such as a computer program product of computer-readable media. The computer program product may be a computer storage medium readable by a computer system and encoding computer program instructions for executing a computer process.

The corresponding structures, material, acts, and equivalents of all means or steps plus function elements in the claims below are intended to include any structure, material or act for performing the function in combination with other claimed elements that are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

Thus various example embodiments of the present disclosure have been described including, but are not limited to:

Example 1 may include an apparatus comprising: identification circuitry to identify, based on an airstream of a cooling device, a first node in a plurality of nodes that is upstream of a second node in the plurality of nodes; assignment circuitry coupled with the identification circuitry, the assignment circuitry to preferentially assign workload to the first node before assigning workload to the second node; and cooling circuitry coupled with the assignment circuitry, the cooling circuitry to alter a cooling rate of the cooling device based on an assignment of workload to the first node.

Example 2 may include the apparatus of example 1, wherein the cooling device is a cooling fan configured to cool the plurality of nodes with the airstream.

Example 3 may include the apparatus of example 1, wherein the plurality of nodes includes a matrix of nodes that includes at least two rows of nodes and at least two columns of nodes, and wherein the first node is in a first row of nodes and the second node is in a second row of nodes that is downstream from the first row of nodes.

Example 4 may include the apparatus of example 3, wherein the identification circuitry is further to identify a third node in the first row of nodes; and

the assignment circuitry is further to assign workload to the third node before assigning workload to the second node.

Example 5 may include the apparatus of any of examples 1-4, wherein a node in the plurality of nodes is a microserver, a system on a chip (SoC), or a central processing unit (CPU).

Example 6 may include the apparatus of any of examples 1-4, wherein the cooling circuitry is to decrease a cooling rate of the cooling device based on an assignment of workload to the first node.

Example 7 may include the apparatus of example 6, wherein the cooling circuitry is to increase the cooling rate of the cooling device based on an assignment of workload to the first node and the second node.

Example 8 may include an electronic device comprising: a cooling device; a plurality of nodes thermally configured to be cooled by the cooling device, wherein a first node in the plurality of nodes is upstream of a second node in the plurality of nodes; and a controller coupled with the plurality of nodes and the cooling device, the controller to preferentially assign workload to the first node before assigning workload to the second node.

Example 9 may include the electronic device of example 8, wherein the controller is further to alter a cooling rate of the cooling device based on an amount of workload assigned to the first node.

Example 10 may include the electronic device of example 8, wherein the cooling device includes a plurality of cooling fans.

Example 11 may include the electronic device of any of examples 8-10, wherein the plurality of nodes includes a matrix of nodes that includes at least two rows of nodes and at least two columns of nodes, and wherein the first node is in a first row of nodes and the second node is in a second row of nodes that is downstream of the first row of nodes.

Example 12 may include the electronic device of example 11, wherein the controller is further configured to assign workload to a third node in the first row of nodes before assigning workload to the second node.

Example 13 may include the electronic device of example 11, wherein a node in the plurality of nodes is a microserver, a system on a chip (SoC), or a central processing unit (CPU).

Example 14 may include one or more non-transitory computer-readable media comprising instructions that cause a controller, when executed by the controller, to: identify a first node in a plurality of nodes that is upstream of a second node in the plurality of nodes in relation to an airstream of a cooling device; and assign, based on a result of the identify, workload to the first node prior to assigning workload to the second node.

Example 15 may include the one or more non-transitory computer-readable media of example 14, wherein the controller is further caused to decrease a cooling rate of the cooling device based on an assignment of workload to the first node.

Example 16 may include the one or more non-transitory computer-readable media of example 15, wherein the controller is further caused to increase the cooling rate of the cooling device based on an assignment of workload to the first node and the second node.

Example 17 may include the one or more non-transitory computer-readable media of any of examples 14-16, wherein the cooling device is a cooling fan configured to cool at least a node of the plurality of nodes with the airstream.

Example 18 may include the one or more non-transitory computer-readable media of any of examples 14-16, wherein the plurality of nodes includes a matrix of nodes that includes at least two rows of nodes and at least two columns of nodes, and wherein the first node is in a first row of nodes and the second node is in a second row of nodes that is downstream from than the first row of nodes in relation to the airstream.

Example 19 may include the one or more non-transitory computer-readable media of example 18, wherein the controller is further caused to assign workload to a third node in the first row of nodes before assigning workload to the second node.

Example 20 may include the one or more non-transitory computer-readable media of any of examples 14-16, wherein a node in the plurality of nodes is a microserver, a system on a chip (SoC), or a central processing unit (CPU).

Example 21 may include a method comprising: identifying, by a controller, a first node in a plurality of nodes that is upstream in an airstream of a cooling device with respect to a second node in the plurality of nodes; assigning, by the controller and based on the identification, workload to the first node prior to assigning workload to the second node; and altering, by the controller and based on the assigning, a cooling rate of the cooling device.

Example 22 may include the method of example 21, further comprising altering, by the controller, the cooling rate of the cooling device to a first setting if the workload is only assigned to the first node; and altering, by the controller, the cooling rate of the cooling device to a second setting if the workload is assigned to the first node and the second node.

Example 23 may include the method of examples 21 or 22, wherein the plurality of nodes includes a matrix of nodes that includes at least two rows of nodes and at least two columns of nodes, and wherein the first node is in a first row of nodes and the second node is in a second row of nodes that is downstream from the first row of nodes in the airstream of the cooling device.

Example 24 may include the method of example 23, further comprising assigning workload to a third node in the first row of nodes before assigning workload to the second node.

Example 25 may include the method of examples 21 or 22, wherein a node in the plurality of nodes is a microserver, a system on a chip (SoC), or a central processing unit (CPU).

Example 26 may include an apparatus comprising means to: identify a first node in a plurality of nodes that is upstream in an airstream of a cooling device with respect to a second node in the plurality of nodes; assign, based on the identification, workload to the first node prior to assigning workload to the second node; and alter, based on the assigning, a cooling rate of the cooling device.

Example 27 may include the apparatus of example 26, further comprising means to alter the cooling rate of the cooling device to a first setting if the workload is only assigned to the first node; and means to alter the cooling rate of the cooling device to a second setting if the workload is assigned to the first node and the second node.

Example 28 may include the apparatus of examples 26 or 27, wherein the plurality of nodes includes a matrix of nodes that includes at least two rows of nodes and at least two columns of nodes, and wherein the first node is in a first row of nodes and the second node is in a second row of nodes that is downstream from the first row of nodes in the airstream of the cooling device.

Example 29 may include the apparatus of example 28, further comprising means to assign workload to a third node in the first row of nodes before assigning workload to the second node.

Example 30 may include the apparatus of examples 26 or 27, wherein a node in the plurality of nodes is a microserver, a system on a chip (SoC), or a central processing unit (CPU).

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. An apparatus comprising:
identification circuitry to identify, based on an airstream of a cooling device, a first node in a plurality of nodes that is upstream of a second node in the plurality of nodes;
assignment circuitry coupled with the identification circuitry, the assignment circuitry to preferentially assign workload to the first node before assigning workload to the second node; and
cooling circuitry coupled with the assignment circuitry, the cooling circuitry to alter a cooling rate of the cooling device based on an assignment of workload to the first node.

2. The apparatus of claim 1, wherein the cooling device is a cooling fan configured to cool the plurality of nodes with the airstream.

3. The apparatus of claim 1, wherein the plurality of nodes includes a matrix of nodes that includes at least two rows of nodes and at least two columns of nodes, and wherein the first node is in a first row of nodes and the second node is in a second row of nodes that is downstream from the first row of nodes.

4. The apparatus of claim 3, wherein the identification circuitry is further to identify a third node in the first row of nodes; and
the assignment circuitry is further to assign workload to the third node before assigning workload to the second node.

5. The apparatus of claim 1, wherein a node in the plurality of nodes is a microserver, a system on a chip (SoC), or a central processing unit (CPU).

6. The apparatus of claim 1, wherein the cooling circuitry is to decrease a cooling rate of the cooling device based on an assignment of workload to the first node.

7. The apparatus of claim 6, wherein the cooling circuitry is to increase the cooling rate of the cooling device based on an assignment of workload to the first node and the second node.

8. An electronic device comprising:
a cooling device;
a plurality of nodes thermally configured to be cooled by the cooling device, wherein a first node in the plurality of nodes is upstream of a second node in the plurality of nodes; and
a controller coupled with the plurality of nodes and the cooling device, the controller to preferentially assign workload to the first node before assigning workload to the second node.

9. The electronic device of claim 8, wherein the controller is further to alter a cooling rate of the cooling device based on an amount of workload assigned to the first node.

10. The electronic device of claim 8, wherein the cooling device includes a plurality of cooling fans.

11. The electronic device of claim 8, wherein the plurality of nodes includes a matrix of nodes that includes at least two rows of nodes and at least two columns of nodes, and wherein the first node is in a first row of nodes and the second node is in a second row of nodes that is downstream of the first row of nodes.

12. The electronic device of claim 11, wherein the controller is further configured to assign workload to a third node in the first row of nodes before assigning workload to the second node.

13. The electronic device of claim 11, wherein a node in the plurality of nodes is a microserver, a system on a chip (SoC), or a central processing unit (CPU).

14. One or more non-transitory computer-readable media comprising instructions that cause a controller, in response to execution of the instructions by the controller, to:
identify a first node in a plurality of nodes that is upstream of a second node in the plurality of nodes in relation to an airstream of a cooling device; and
assign, based on a result of the identify, workload to the first node prior to assigning workload to the second node.

15. The one or more non-transitory computer-readable media of claim 14, wherein the controller is further caused to decrease a cooling rate of the cooling device based on an assignment of workload to the first node.

16. The one or more non-transitory computer-readable media of claim 15, wherein the controller is further caused to increase the cooling rate of the cooling device based on an assignment of workload to the first node and the second node.

17. The one or more non-transitory computer-readable media of claim 14, wherein the cooling device is a cooling fan configured to cool at least a node of the plurality of nodes with the airstream.

18. The one or more non-transitory computer-readable media of claim 14, wherein the plurality of nodes includes a matrix of nodes that includes at least two rows of nodes and at least two columns of nodes, and wherein the first node is in a first row of nodes and the second node is in a second row of nodes that is downstream from the first row of nodes in relation to the airstream.

19. The one or more non-transitory computer-readable media of claim 18, wherein the controller is further caused to assign workload to a third node in the first row of nodes before assigning workload to the second node.

20. The one or more non-transitory computer-readable media of claim 14, wherein a node in the plurality of nodes is a microserver, a system on a chip (SoC), or a central processing unit (CPU).

21. A method comprising:
identifying, by a controller, a first node in a plurality of nodes that is upstream in an airstream of a cooling device with respect to a second node in the plurality of nodes;
assigning, by the controller and based on the identification, workload to the first node prior to assigning workload to the second node; and
altering, by the controller and based on the assigning, a cooling rate of the cooling device.

22. The method of claim 21, further comprising altering, by the controller, the cooling rate of the cooling device to a first setting if the workload is only assigned to the first node; and altering, by the controller, the cooling rate of the cooling device to a second setting if the workload is assigned to the first node and the second node.

23. The method of claim 21, wherein the plurality of nodes includes a matrix of nodes that includes at least two rows of nodes and at least two columns of nodes, and wherein the first node is in a first row of nodes and the second node is in a second row of nodes that is downstream from the first row of nodes in the airstream of the cooling device.

24. The method of claim 23, further comprising assigning workload to a third node in the first row of nodes before assigning workload to the second node.

25. The method of claim 21, wherein a node in the plurality of nodes is a microserver, a system on a chip (SoC), or a central processing unit (CPU).
